(19) United States
(12) Patent Application Publication
(10) Pub. No.: US 2021/0361394 A1
(43) Pub. Date: Nov. 25, 2021

(54) APPARATUS FOR DENTAL PROSTHETIC PROCEDURE

(71) Applicant: David Hyun Jong Cho, Citrus Heights, CA (US)

(72) Inventor: David Hyun Jong Cho, Citrus Heights, CA (US)

(21) Appl. No.: 16/879,600

(22) Filed: May 20, 2020

(51) Int. Cl. A61C 8/00; A61C 9/00

(52) U.S. Cl. CPC A61C 8/0045; A61C 8/0037; A61C 8/0075; A61C 8/0068; A61C 8/0089; A61C 9/0006; A61C 8/0066

(57) ABSTRACT

A dental anchor that is easily planted into a target space created by a lost tooth is presented. The dental anchor has a root portion made to extend into and contact bone tissue and a trunk portion directly attached to the root portion and disposed above gumline. A dental anchor planting apparatus that facilitates the precise planting of the dental anchor is also presented. The apparatus includes a main support and a chinrest, an impression tray, a dental anchor, and a nose bridge support all connected to the main support. The dental anchor of the disclosure may be used instead of a traditional dental implant to shorten procedure time and lower risks of infection and bone damage.

### TECHNICAL FIELD

The disclosure relates to a method and apparatus for implanting a dental prosthetic.

### BACKGROUND

A dental implant is a common surgical component that is used to fill the space left by loss of a natural tooth (this space will be referred to as the “target space”). As depicted in FIG. 1, generally, the dental implant procedure involves three parts: an implant 2, an abutment 4 (shown as dotted area), and a dental prosthesis 6. The implant 2 generally has a cylindrical shape and is drilled into the bone 1 of the jaw or skull to serve as an anchor. The abutment 4 is a construction part that securely fastens to the implant 2, and connects to the dental prosthesis 6. The dental prosthesis, which is disposed on the portion of the abutment 4 above the gumline 7, may be a crown or a bridge, among other possibilities. “Gumline,” as used herein, refers to the surface of the gum tissues that is farthest from bone tissues 1. The implant 2 may be available in different sizes, and the dentist or dental surgeon may select the right size for a patient depending on her bone structure.

In some cases, the implant 2 includes threads on its inner wall to receive a screw 8 that fixes the abutment 4 to the implant 2. The abutment 4 has a through-hole 3 extending through its height, allowing a small screw driver to fasten the abutment 4 to the implant 2 with a screw 8 extending into a hollow portion of the implant 2.

It is important for the implant 2 to provide good osseointegration. The term “osseointegration” designates the direct structural and functional connection between living bone tissues 1 and the surface of the implant 2 (typically titanium) that is drilled into the bone. A “good” osseointegration means that the implant 2, after reaching a primary stability by being drilled into the bone tissues 1, safely ossifies within a short healing time so that a permanent bond between implant and bone is obtained.

Unfortunately, not every patient's bone reacts well to the implant 2. In some cases, the bone's reaction to the foreign material results in an infection at the implant site. In other cases, there is damage to surrounding structures such as teeth or bone.

Even aside from the risks mentioned above, the dental implant procedure has the downside associated with long completion time and numerous appointments. Typically, a patient gets the implant 2 put in, waits a few months, and gets the abutment 4 fastened. After the gum is healed, in a third appointment, impressions of the area around the abutment are taken. A crown is prepared based on the impression, and the patient has to return to put the crown on.

A way to replace a lost tooth with a dental prosthetic without the above-mentioned disadvantages is desired.

### SUMMARY OF THE DISCLOSURE

According to one aspect of the inventive concept, a dental anchor has a root portion made to extend into and contact bone tissue, and a trunk portion directly attached to the root portion and disposed above gumline.

According to another aspect, the inventive concept pertains to a dental anchor planting apparatus having a main support and a chinrest, an impression tray, a dental anchor, and a nose bridge support all connected to the main support.

### DESCRIPTION OF THE DRAWINGS

FIG. 1 depicts a conventional dental implant.

FIG. 2, FIG. 3, FIG. 4, and FIG. 5 each depicts a dental anchor in accordance with an embodiment of the inventive concept.

FIG. 6A depicts a gum cutter that may be used with the dental anchor of this disclosure, in accordance with an embodiment of the inventive concept.

FIG. 6B depicts the gum cutter pressed into the gum.

FIG. 6C depicts a temporary crown placed on the dental anchor, in accordance with an embodiment of the inventive concept.

FIG. 6D shows the healing cap in accordance with an embodiment of the inventive concept.

FIG. 7 depicts a horizontal cross section of a trunk portion of a dental anchor, in accordance with an embodiment of the inventive concept.

FIG. 8 depicts a permanent crown placed over the dental anchor, in accordance with an embodiment of the inventive concept.

FIG. 9A and FIG. 9B each depicts a dental anchor planting apparatus in accordance with an embodiment of the inventive concept.

FIG. 10 depicts the dental anchor planting apparatus place on a patient, in accordance with an embodiment of the inventive concept.

FIG. 11 depicts the impression tray of the dental anchor planting apparatus being used on a patient's teeth, in accordance with an embodiment of the inventive concept.

### DETAILED DESCRIPTION

A dental prosthetic that may be used to fill the space created by loss of a tooth without the long healing time is presented.

In this disclosure, like reference numerals in the drawings denote like elements, and thus a repeated description of those similar elements will be omitted.

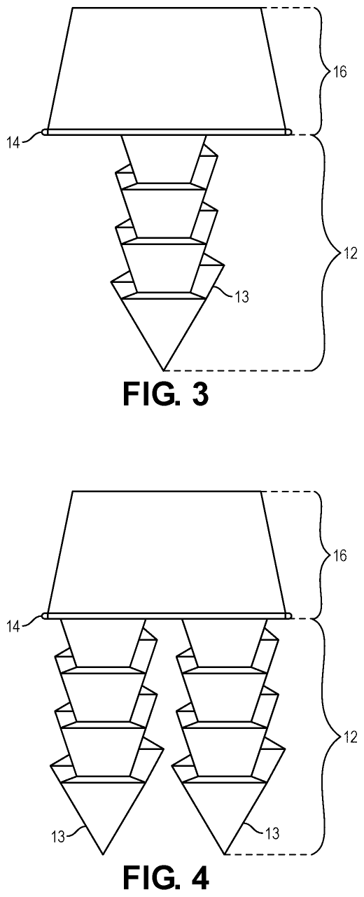

FIG. 2 depicts a dental anchor 10 in accordance with an embodiment of the inventive concept. As shown, the dental anchor 10 includes a root portion 12 and a trunk portion 16. The trunk portion 16 includes a platform 14 that sits on the bone tissue 1 and stops the dental anchor 10 from going into the bone tissue 1 further. The root portion 12, which may be made of titanium, includes one or more roots 13, each of the roots 13 being thinner than the anchoring part that is typically used in the conventional dental implant. The root portion 12 and the trunk portion 16 (including the platform 14) may be formed as a single integrated piece. The trunk portion 16 has a screw hole 18 extending into it from the top surface for attaching the prosthetic (explained below). The platform 14, although not clearly shown, may be wider than the rest of the trunk portion 16. A patient may, instead of getting an implant drilled into his bone, waiting a few months, and returning for a second appointment to get the abutment fastened, get the dental anchor 10 planted into her bone in a single appointment. The length of the root 13 may be adjusted/selected according to the bone structure of the patient.

To plant the dental anchor 10, the space in the mouth that is intended to be filled may be put under local anesthesia. The dental anchor 10 is placed above the gum in the space with the root portion 12 closest to the gum. Then, a pressure is applied on the trunk portion 16 gently and steadily into the target space, pushing the root portion 12 into the bone tissues 1. The root portion 12 has a pointy end such that it extends into the gum and into the bone underneath. The platform 14 stops the dental anchor 10 when the dental anchor 10 is pushed in to a desired depth. The length of the root portion 12 may be adjusted and/or selected before the insertion.

There will be a waiting period after the dental anchor 10 is planted and before the crown is placed, to allow the root portion 12 to settle into the bone securely. However, this waiting period is significantly shorter (in the range of 2-4 weeks) than the 3-4 month waiting period associated with the traditional dental implant procedure after the anchoring part is implanted. Also, due to the fact that almost no bone removal is required, the risk of infection or structural damage is significantly lower than with the conventional dental implant.

FIG. 2 depicts the dental anchor 10 in accordance with one embodiment of the inventive concept. Specifically, this embodiment has a spiral-shaped or twisted root 13. As pressure is applied on the dental anchor 10 toward the gum, the dental anchor 10 is turned (usually by less than 360°) to plant the spiral root portion 12 into the gum and into the bone until stopped by the platform 14. The end of the root 13 that is farthest away from the trunk portion 16 may be pointy, to help with the planting.

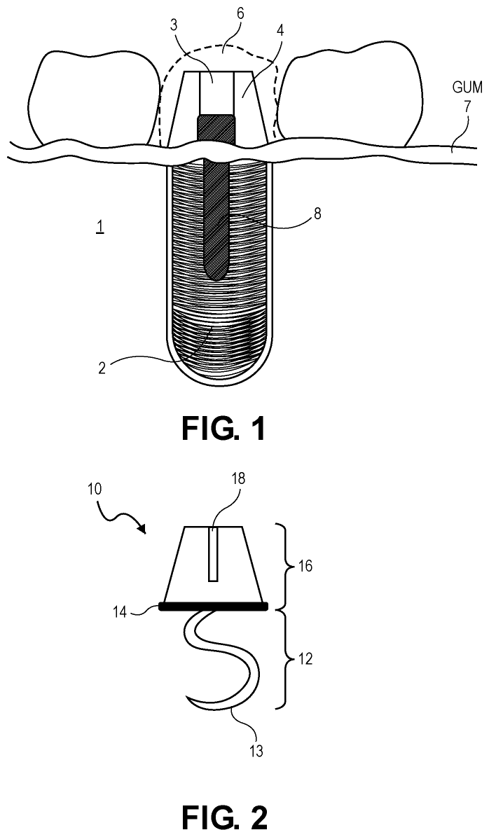

FIG. 3 depicts the dental anchor 10 in accordance with another embodiment of the inventive concept. The root portion 12 in this embodiment has a textured surface that includes a pointy tip and a generally polyhedron or cone shape with steps formed on the side surface(s). The widest portion of the polyhedron or prism-shaped root is attached to the platform 14. Portions of the side surface is removed to create flat portions (steps) such that the root portion 12 goes into the bone easily but does not come back out as easily. FIG. 4 depicts the dental anchor 10 having two textured roots. In another embodiment, the dental anchor 10 may have three textured roots. The inventive concept is not limited by the number of roots in a dental anchor. The length of the textured root is significantly less than (e.g., half of) the length that a traditional implant (such as implant 2 of FIG. 1) would have been for the same secure attachment.

The trunk portion 16 and the root portion 12 of the dental anchor 10 in accordance with the inventive concept are integrally formed, as a single piece. Hence, the root portion 12 is not detachable from the trunk portion 16.

FIG. 5 depicts a dental anchor 10 with a spiral-shaped root and a textured surface, in accordance with an embodiment of the inventive concept. The root 13 in this embodiment is textured with steps carved into the side, similarly to the embodiment of FIG. 3, and twisted into a generally spiral shape. Due to the spiral shape, this dental anchor 10 would be turned when it is planted into the gum and bone.

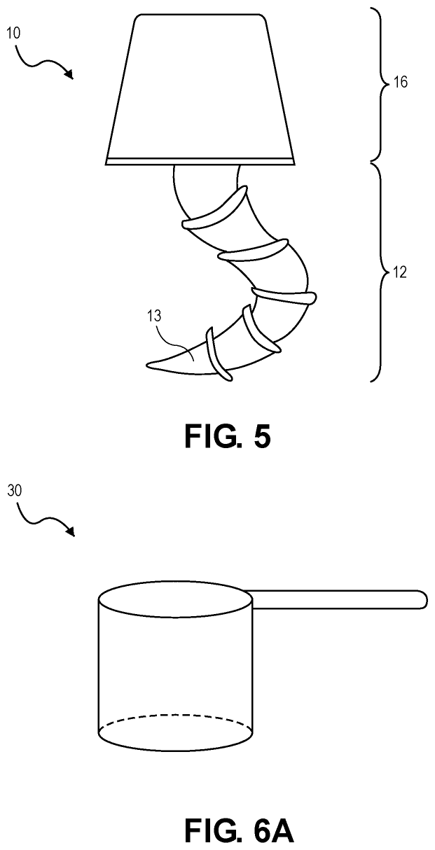

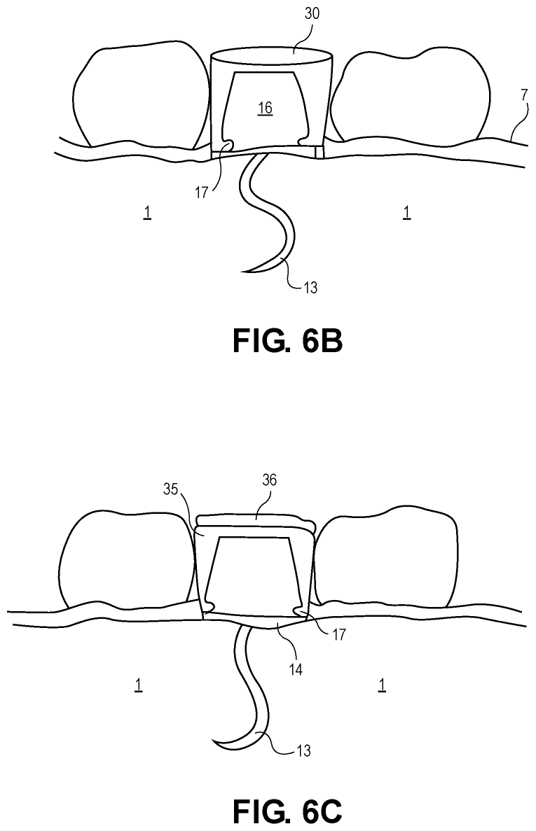

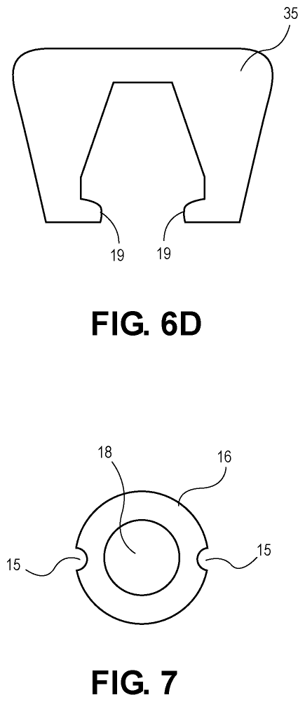

After the dental anchor 10 is planted and settled, crown preparation happens. To securely attach the crown around the trunk portion 16, gum tissues around the trunk portion 16 are removed. This gum opening may be done in a number of ways, one of which is to use a gum cutter 30. The gum cutter 30, an embodiment of which is depicted in FIG. 6A, functions like a “cookie cutter” to remove the excess gum tissue around the trunk portion 16. Although FIG. 6A depicts the gum cutter 30 with a ring blade having a circular cross section, any other shape may be used. The gum cutter 30 is selected to be the right size for the particular patient and tooth space. To achieve this removal, the gum cutter 30 is positioned above the gum aligned with the target space. When the gum cutter 30 is pressed into the gum, the entire trunk portion 16 will be enclosed by the wall(s) of the gum cutter 30. FIG. 6B depicts the gum cutter 30 pressed into the gum. As the gum cutter 30 is pressed into the gum, the wall(s) of the cutter 30 cuts into the gum, allowing accurate removal of the unwanted tissues from the target space.

Once excess gum tissue is removed, a healing cap 35 (e.g., made of plastic) may be placed around the trunk portion 16, on the platform 14. The healing cap 35 is sized to fit perfectly into the space (i.e., it is of approximately the same diameter/width as the gum cutter 30), and may be used to cover the trunk portion 16, as shown in FIG. 6C.

The healing cap 35 is securely attached to the trunk portion 16 by “locking” into a retention groove 17. The retention groove 17 is formed on the trunk portion 16 near the base that connects to the platform 14. The retention groove 17 looks as though a section of the trunk portion 16 has been removed. In the example that is depicted in FIG. 6C, there are two retention grooves 17. The healing cap 35, as shown in FIG. 6D, has a protrusion 19 positioned and sized to fit into the retention groove 17 (e.g., a complementary shape to the retention groove 17). With the protrusion 19 “locked” into the retention groove 17, the healing cap 35 is securely attached to the trunk 16.

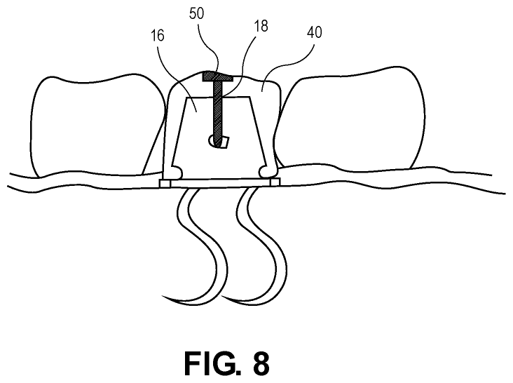

Prior to placement of the temporary crown, an impression is taken of the area around the trunk portion 16 so a permanent crown can be prepared. Eventually, the temporary crown 36 and the healing cap 35 are removed and replaced by a permanent crown. When the temporary crown 36 and the healing cap 35 are removed, taking off the healing cap 35 is sometimes difficult, due to the secure attachment of the protrusion 19 to the retention groove 17. To reduce the amount of discomfort to the patient or the dentist from the force required to take off the healing cap 35, the trunk portion 16 of the dental anchor 10 may have grooves 15 extending down its side, in a direction orthogonal to the platform 14. The healing cap can be taken off by turning it so the protrusion 19 is aligned with the groove 15, then sliding it up the groove 15. FIG. 7 shows a horizontal cross section of the trunk portion 16 in accordance with an embodiment, depicting two grooves 15 formed on approximately opposite sides. The trunk portion 16 has a screw hole 18 extending partway through it from the top and stopping a predefined distance above the platform 14. As will be explained below in reference to FIG. 8, this screw hole 18 is used for attaching the permanent dental prosthetic (e.g., crown).

When the permanent crown is ready, a screw may be used to fix the permanent crown in place. The permanent crown has an opening at the occlusal surface to accommodate the screw. FIG. 8 shows the screw 50 placed into the opening in the crown 40 and extending into the screw hole 18 of the trunk portion 16 of the dental anchor 10. To hold the crown 40 in place, the screw 50 extends from the surface of the crown 40 and into the trunk portion 16 but not all the way through the trunk portion 16. The screw 50 does not extend into the bone or an area surrounded by the bone below the gum line. In accordance with the inventive concept, the screw 50 extends partway—less than all the way—through the height of the trunk portion 16.

Use of the screw with the dental anchor 10 of this disclosure is distinguishable from use of the screw in the conventional dental implant technique. With the conventional implant technique, the through hole 3 (see FIG. 1) extends all the way from top to bottom of the abutment 4 to accommodate the insertion and installation of the screw 8 into the implant 2, resulting in the screw extending below the gum line to an area that was previously occupied by the bone tissues 1. In some cases, there is an opening in the crown 6 allowing the screw to be inserted after the crown 6 is in place. After the screw 8 is in place, the through hole 3 is filled with appropriate material before the crown 6 is placed. In other cases, with the traditional implant, there is no hole in the crown and the crown is glued or cemented onto the trunk portion 16 after the through-hole 3 is filled.

Use of the screw 50 extending through the top portion of the crown 40 and part of the trunk portion 16 simplifies the prosthetic procedure. One of the disadvantages of the traditional process is that aligning all the parts to properly place a screw into the implant 2 is challenging. Moreover, if a problem arises later and the crown needs to be removed, removal of the cemented crown is messy and difficult. With the screw 50 of the disclosure, both the attachment and detachment of the crown is simplified to putting in and taking out of the screw 50. There is no cement inside the crown that is necessary. For the detachment, a material at the top of the crown 50 that was placed to cover up the screw 50 is removed (e.g., chemically or mechanically) before the screw 50 is taken out.

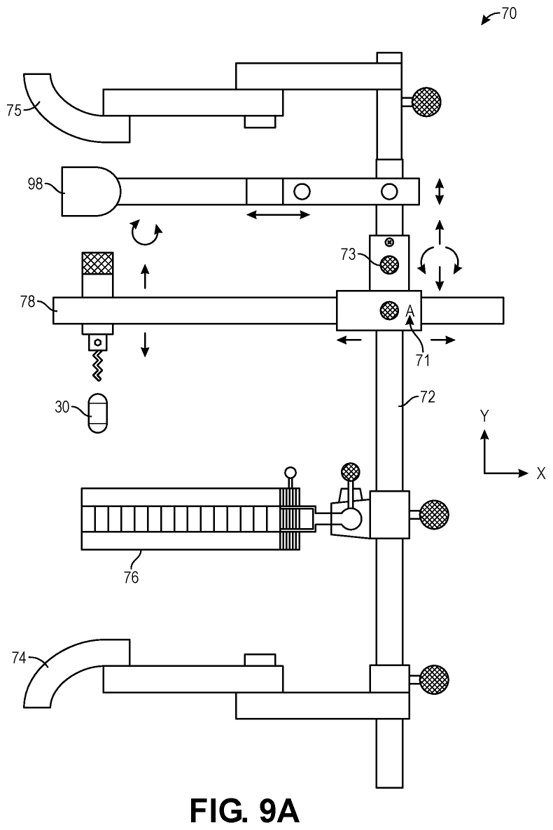

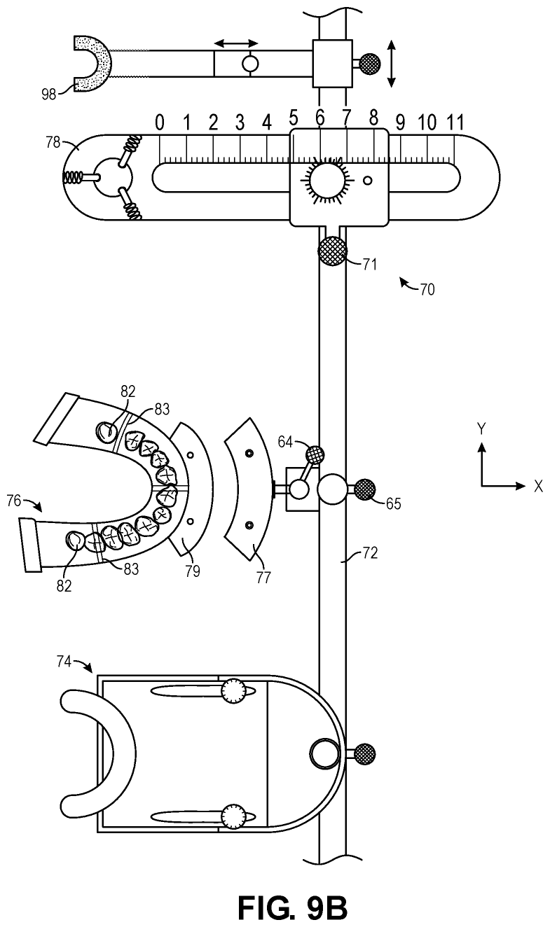

FIG. 9A depicts a dental anchor planting apparatus 70 that may be used to plant the dental anchor 10. As shown, the dental anchor planting apparatus 70 includes a main support 72, a chinrest plate 74, an impression tray 76 and an anchor holder arm 78. The dental anchor planting apparatus 70 may have a nose bridge support 98 to provide the patient additional comfort. Some embodiments may also include a headrest 75. While the dental anchor 10 may be implanted without using the dental anchor planting apparatus 70, the dental anchor planting apparatus 70 facilitates the implant process.

The specific settings of the dental anchor planting apparatus 70, which differ from patient to patient, may be determined by first having a patient rest his chin on the chinrest 74, which is usually a curved plate. The position of the chinrest 74 is adjustable. Once the chin is resting on the chinrest 74, the impression tray 76 may be used. The impression tray 76 is detachable from the main support 72 by loosening the pins on an attachment plate 77, as shown in FIG. 9B. The impression tray 76 is fitted over the lower/upper teeth of the patient, and silicon material is injected for impression. A small, cylindrical placeholder piece 82, which may be made of plastic, may be disposed in the part of the impression tray 76 that covers the target space. In one embodiment, the inner walls of the impression tray 76 is thick enough that the placeholder piece 82 can be held in place between the inner walls. The silicone material is filled around the placeholder piece 82 and the teeth, so that there will be an opening through which the dental anchor 10 can be planted. The placeholder piece 82 may be about the same size as, or slightly wider than, the dental anchor 10.

After the silicone material is hardened, it is taken out of the patient's mouth. The placeholder piece 82 may be removed, and the impression tray is re-attached to the main support 72 by joining the attachment plates 77, 79. When this reattachment happens, the impression tray 76 is positioned parallel with the chinrest 74. Adjustment knobs 64, 65 which control a ball attachment that connects to the attachment plate 77, may be used to fine-tune the position of the impression tray 76 with respect to the chinrest 74. Adjustment knob 64 allows the angle of the impression tray 76 to be fine-tuned. The adjustment knob 65 adjusts the position of the impression tray 76 along the y-axis (vertically with respect to the figure).

The dental tray 76 has bridge pieces 83 that help capture the occlusal plane. The bridge pieces 83 may be movably attached across the top surface of the portion of the impression tray 76 where the silicone is injected. Capturing the occlusal plane accurately is important for planting of the dental anchor 10 at the correct angle. When the impression tray 76 is positioned over a patient's teeth, the bridge pieces 83 control how “deeply” the impression tray 76 goes in. In other words, once the bridge pieces 83 contact the teeth, the impression tray 76 cannot go any “deeper.” The silicone material is injected with the bridge pieces 83 sitting on top of the teeth.

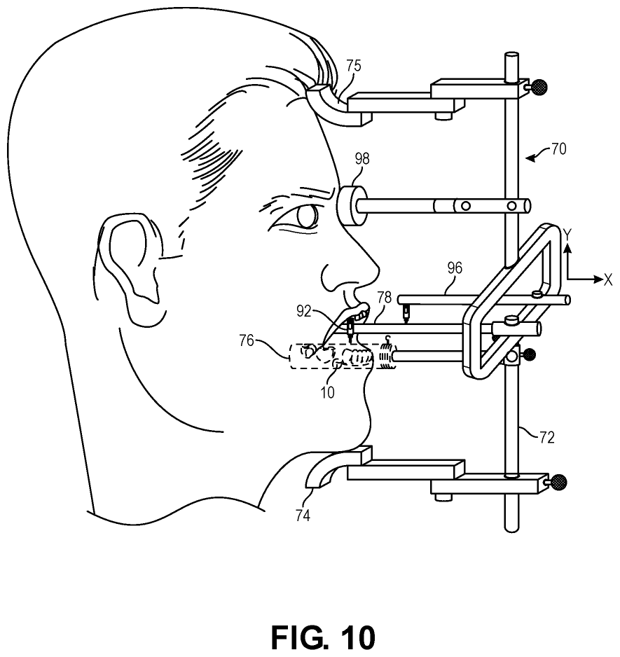

The patient places his teeth back in the impression tray while the impression tray is still connected to the main support 72, as shown in FIG. 10. The chinrest 74 is moved up toward the patient's chin until his chin is resting on the chinrest 74. The position of the patient's jaw is “fixed” between the chinrest 74 and the impression tray 76. The angle of the impression tray 76 is adjusted such that the occlusal plane of the teeth make a 90°-angle with the main support 72. This 90°-angle ensures that the dental anchor 10 will be planted “straight” into the bone tissue 1, or orthogonally to the occlusal plane that is captured by the bridge pieces 83. In this position, the nose bridge support 98 and the headrest 75 make contact with the patient's face. Now, the dental anchor 10 is ready to be implanted using the anchor holder arm 78. At some point prior to the implant, a preselected dental anchor 10 is placed in the anchor holder 92 of the anchor holder arm 78. While the patient has his mouth open, the dental anchor 10 is placed in his mouth via the anchor holder 92, positioned over the target space, and pressed into the gum and/or bone tissues. The arm 78 holding the dental anchor 10 may be adjusted along the x-axis or the y-axis using appropriate mechanisms. An adjustment mechanism 71 allows the position of the anchor holder 78 to be adjusted along the x-axis, and an adjustment knob 73 allows the position of the anchor holder arm 78 to be adjusted along the y-axis or be rotated with respect to the main support 72. In some embodiments, a “drill”-type anchor holder 92 holds the dental anchor 10 and allows the dental anchor 10 to be slowly turned as it is pressed into the patient's gum (e.g., for if the dental anchor 10 has a spiral-type root). A wrench 96 may also be used to help with any drilling during the implant process.

Although FIG. 10 shows the impression tray 76 being used for lower teeth, the impression tray 76 may be used to hold the upper teeth in place for a procedure. In one embodiment, the main support 72 may be rotated 180° so that it is vertically inverted into an “upside down” position. Effectively, this vertical inversion turns the headrest 75 into the chinrest 74, and vice versa, while changing the orientation of the implant tray 76 so that it can be used for the upper teeth. The position of the impression tray 76 along the main support 72 is adjustable. Other parts such as the nose rest 98 and the anchor holder arm 78 may be moved, for example by detaching and re-attaching at different positons along the main support 72.

For a single implant, multiple implants, or bridge, the anchor holder 92 is aligned with the occlusal surface of the teeth full arch. Where multiple implants are being handled in a single procedure, the mechanisms for adjusting the position of the dental anchor 10 are used to change the position of the anchor holder 92 and the anchor holder arm 78 between each implant. A new dental anchor 10 is placed in the anchor holder 92 for each procedure.

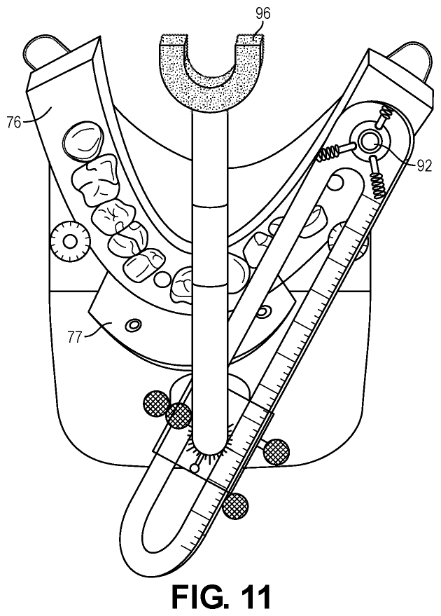

FIG. 11 depicts, in greater detail, how the impression tray 76 encloses the teeth and the holder 92 is positioned above the target space. FIG. 11 shows an opening in the silicone mold after the placeholder piece 82 is removed. The anchor holder 92 is placed over the opening with the right-sized dental anchor 10 attached to it, so that the dental anchor 10 is pressed into the gum and into the bone tissue 1 underneath the gum.

The dental anchor planting apparatus 70 may also be used to place the healing cap 35 as depicted in FIG. 6C. In one embodiment, when the anchor holder 92 is not holding a dental anchor 10, the “fingers” that hold the dental anchor 10 may be arranged in a polygonal configuration, such as a triangle or a rectangle. The healing cap 35 may have an imprint on its top outer surface that has the matching polygonal shape, such as a triangle or a rectangle. The fingers of the anchor holder 92 can “hold” the healing cap 35 by having each finger in the corner of the polygon with mild outward force. The healing cap 35 is then placed around the trunk portion 16 that is already planted by having the protrusion 19 (shown in FIG. 6D) slide down the grooves 15 (shown in FIG. 7), and turned until it is locked into the retention grooves 17 (shown in FIG. 6C).

The dental anchor planting apparatus 70 may be especially useful for avoiding a stent or diagnostic wax-up where there are two or more missing teeth in adjacent locations. Diagnostic wax-up is often beneficial for patients, as they usually produce more aesthetically-appealing results and better mastication function. This is due to the fact that diagnostic was-up can help avoid implanting abutments at incorrect angles. However, dentists sometimes avoid the diagnostic wax-up procedure to save cost. Using the dental anchor planting apparatus 70 with the built-in angle-adjustment capability described above may avoid angled or tilted implants without the cost of a diagnostic wax-up.

In the preceding specification, the inventive concept has been described with reference to specific exemplary embodiments. It will, however, be evident that various modifications and changes may be made without departing from the broader spirit and scope of the inventive concept as set forth in the claims that follow. The specification and drawings are accordingly to be regarded as illustrative rather than restrictive. Other embodiments of the inventive concept may be apparent to those skilled in the art from consideration of the specification and practice of the concept disclosed herein.

What is claimed is:

1. A dental anchor comprising:
a root portion made to extend into and contact bone tissue; and
a trunk portion directly attached to the root portion and disposed on the bone tissue.

2. The dental anchor of claim 1, wherein the root portion has a twisted spiral shape.

3. The dental anchor of claim 2, wherein the root portion further comprises steps formed on its surface.

4. The dental anchor of claim 1, wherein the root portion has a cone shape with a pointy end farthest from the trunk portion and steps formed on a side surface.

5. The dental anchor of claim 1, wherein the root portion has a polyhedron shape with a pointy end farthest from the trunk portion and steps formed on one or more side surfaces.

6. The dental anchor of claim 1, further comprising a screw hole extending from an occlusal surface of the trunk portion partway into the trunk portion.

7. The dental anchor of claim 1 further comprising grooves formed on outer surface of the trunk portion.

8. The dental anchor of claim 1, wherein the trunk portion and the root portion are integrally formed.

9. The dental anchor of claim 1, further comprising a retention groove formed at a base of the trunk portion to accommodate a protrusion in a dental prosthetic.

10. A dental anchor planting apparatus comprising:
a main support;
a chinrest connected to the main support;
an impression tray connected to the main support;
a dental anchor holder arm connected to the main support; and
a nose bridge support connected to the main support.

11. The dental anchor planting apparatus of claim 10, wherein positions of the chinrest, the impression tray, the dental anchor holder arm, and the nose bridge support are independently adjustable.

12. The dental anchor planting apparatus of claim 10, wherein the dental anchor holder arm includes an anchor holder that holds a dental anchor as the dental anchor is planted in a target space, wherein the anchor holder is configured to turn.

13. The dental anchor planting apparatus of claim 10, wherein the impression tray is detachable from the main support.

14. The dental anchor planting apparatus of claim 10, wherein the impression tray has at least one bridge piece extending across its top surface, the bridge piece positioned to control placement of the impression tray over teeth and mark an occlusal plane.

15. The dental anchor planting apparatus of claim 14, wherein the chinrest and the impression tray, after a patient's impression is taken, fix the patient's head in a position where the occlusal plane and the main support make a 90° angle.

16. The dental anchor planting apparatus of claim 10, wherein the position of the dental anchor holder arm relative to the main support is adjustable.

17. The dental anchor planting apparatus of claim 10, further comprising a wrench connected to the main support.

18. The dental anchor planting apparatus of claim 10, further comprising a headrest connected to the main support and a rotating mechanism to put the main support in an upside down position such that the headrest functions as the chinrest in the upside down position.

19. A method of filling a target space in a patient's mouth, comprising:
obtaining a dental anchor that has a root portion extending from a trunk portion, wherein the root portion has a pointy end that extends into and contacts bone tissue under the target space, and the trunk portion is positioned above the bone tissue in the target space, the trunk portion having a first screw hole on an occlusal surface that extends partway into the trunk portion;
pressing the dental anchor into the bone tissue under the target space;
placing a crown on top of the trunk portion, the crown having a second screw hold in its occlusal surface; and
extending a screw through the first screw hole and the second screw hole to fix the crown to the dental anchor.
